(19) United States
(12) Patent Application Publication
(10) Pub. No.: US 2026/0139529 A1
(43) Pub. Date: May 21, 2026

(54) SECURITY RETRACTABLE LATCH WITH ANTI-IMPACT UNLOCKING FUNCTION

(71) Applicant: e-BI International Technologies (Shenzhen) Co., Ltd., Shenzhen (CN)

(72) Inventors: Peiwei Yang, Shenzhen (CN); Yuhui Lv, Shenzhen (CN); Xiangyi Liu, Shenzhen (CN); Zhihai Wang, Shenzhen (CN)

(21) Appl. No.: 19/452,864

(22) Filed: Jan. 19, 2026

(30) Foreign Application Priority Data
Dec. 6, 2025 (CN) 2025118309179

(51) Int. Cl. E05C 1/10

(52) U.S. Cl. CPC E05C 1/10

(57) ABSTRACT

The present invention relates to the technical field of safety and protective mechanical structures, and discloses a security retractable latch with an anti-impact unlocking function. It aims to solve the problems of existing portable bag magnetic latches being prone to mis-unlocking due to external impact and the risk of contact injury from fixed steel pins. The latch comprises a pressing assembly and a latch assembly. The pressing assembly features a split connection between the steel pin and the metal button allowing for free travel, while the latch assembly contains an unlocking core set with steel balls, a magnetic casting, and a core spring. The anti-impact mis-unlocking function is achieved through the impact response time difference formed by the split structure and free travel, combined with the synergistic effect of multiple grooves on the steel pin and the core spring, while maintaining the retractability of the steel pin, to balance security and convenience. It is suitable for various fields such as portable storage, smart devices, and public lockers.

### TECHNICAL FIELD

The present invention relates to the technical field of safety and protective mechanical structures, and specifically, to a security retractable latch with an anti-impact unlocking function

### BACKGROUND ART

It is well recognized that magnetic latches are commonly used in existing portable storage bags (e.g., bags for storing mobile phones and smart wearable devices). One type features a retractable pin assembly with a press button that engages with a magnetic core. When the button is pressed, a steel pin extends to engage and lock, while unlocking is achieved by attracting the magnetic component using a dedicated magnetic unlocker. Another type employs a fixed steel pin that engages with a magnetic core but lacks a retractable function.

However, the aforementioned structures have drawbacks. In retractable types, the steel pin and the plastic button often form an integrated, overmolded injection structure. When an external force impacts the latch head, the position of the internal steel balls may loosen easily. Due to the return force of the pressing spring, the integrated structure of the steel pin and button may cause the steel pin to bounce up momentarily upon impact, leading to unauthorized unlocking. Although the fixed steel pin structure offers better resistance to impact-induced mis-unlocking, the constantly exposed steel pin poses a risk of contact injury, making it difficult to balance security and convenience. There is an urgent need to solve the above problems through structural optimization.

### SUMMARY OF THE UTILITY MODEL

### Technical Problem to Be Solved

To address the deficiencies in the prior art, the present invention provides a security retractable latch with an anti-impact unlocking function.

### Technical Solution

To achieve the above objective, the present invention provides the following technical solution: A security retractable latch with an anti-impact unlocking function, comprising a pressing assembly and a latch assembly.

The pressing assembly comprises a steel pin, a metal button, a metal button cover, a pressing upper housing, a pressing lower housing, and a pressing spring. The steel pin is passed through a central hole of the metal button, with the large end of the steel pin positioned at a step portion inside the central hole. The metal button cover is screwed into the internal thread of the metal button via an external thread, allowing the steel pin to slide axially between the metal button and the metal button cover, thereby forming a free travel A. The pressing spring is sleeved over a pillar section of the metal button. Both the pressing upper housing and the pressing lower housing are equipped with limit ribs that engage with recessed limit ribs on the metal button, and the upper and lower housings are fixedly connected via engaging clips and positioning posts.

The latch assembly comprises an unlocking core set, a latch upper housing, and a latch lower housing. The unlocking core set consists of a core soft shell, a core conical cover, a core magnetic casting, steel balls, and a core spring. The core magnetic casting is equipped with steel ball grooves on its periphery and an engagement slot at its bottom, with one end of the core spring embedded in the engagement slot. The top of the core magnetic casting is nested against an inner wall of the core conical cover, and angled protrusions on the outer wall of the core conical cover engage with corresponding inner grooves of the core soft shell. The unlocking core set is positioned within a core slot of the latch upper housing, and the latch lower housing is provided with an annular retaining portion that restricts wobbling of the unlocking core set. The latch upper housing and the latch lower housing are fixedly connected.

To improve the functional performance, in an improved embodiment of the present invention, the steel pin body is provided with at least two sets of grooves along its axial direction. The mass of the metal button is greater than the mass of the core magnetic casting, and the spring force of the pressing spring is less than the spring force of the core spring.

To enhance the functional performance, in an improved embodiment of the present invention, the steel pin is made of 316 stainless steel material, and the free travel A ranges from 2 mm to 6 mm.

To enhance the functional performance, in an improved embodiment of the present invention, three steel balls are provided, correspondingly cooperating with the steel ball grooves on the periphery of the core magnetic casting.

To enhance the functional performance, in an improved embodiment of the present invention, the pressing upper housing and the pressing lower housing are made of plastic material, and the latch upper housing and the latch lower housing are fixed by ultrasonic welding.

To enhance the functional performance, in an improved embodiment of the present invention, the steel pin body is provided with three sets of grooves along its axial direction, namely a first groove, a second groove, and a third groove, wherein the spacing between adjacent sets of grooves is adapted to the free travel A.

### Advantageous Effects

Compared with the prior art, the present invention provides a security retractable latch with an anti-impact unlocking function, which has the following advantageous effects:

This security retractable latch demonstrates a remarkable resistance to impact-induced mis-unlocking: Through the split structure between the metal button and the steel pin and the free travel design, combined with the mass difference between the metal button and the core magnetic casting and the spring force difference between the pressing spring and the core spring, the metal button responds and moves preferentially under external impact, thereby creating a time difference with the steel pin. The core spring rapidly pushes the steel balls to re-clamp the steel pin, preventing the steel pin from disengaging, thus solving the mis-unlocking issue found in traditional integrated structures.

The safety retraction function is reliable: The steel pin retracts into the pressing assembly in the non-working state and extends only during the locking operation, thereby avoiding the risk of contact injury associated with fixed steel pins. Simultaneously, the return structure driven by the pressing spring ensures that the steel pin automatically resets after unlocking, enhancing operational safety.

The structure exhibits high stability: The limit rib and clip designs in the pressing assembly, together with the annular retaining portion and ultrasonically welded housings in the latch assembly, provide firm interconnections between components and effectively prevent loosening during prolonged operation. The circumferential uniform cooperation between the multiple grooves on the steel pin and the three steel balls further enhances locking stability; even if an impact causes slight displacement of the steel pin, it remains securely clamped by the steel balls positioned between adjacent grooves.

Wide applicability: The structure is compact and small, allowing integration into products such as portable storage bags, smart device charging cases, and public lockers without the need for complex adaptation. It meets safety locking requirements across various application scenarios, demonstrating strong practicality.

### BRIEF DESCRIPTION OF THE DRAWINGS

FIG. 1 is an exploded schematic view of the security retractable latch with an anti-impact unlocking function according to the present invention.

FIG. 2 is a cross-sectional schematic view of the assembled latch in its natural state according to the present invention.

FIG. 3 is a cross-sectional schematic view of the assembled latch in its locked state according to the present invention.

FIG. 4 is a partially exploded schematic view of the pressing assembly and an enlarged view of the steel pin according to the present invention.

FIG. 5 is a partially exploded schematic view of the latch assembly and an enlarged view showing the steel ball engagement angle according to the present invention.

Reference Numerals: 1: steel pin; 000: first groove; 001: second groove; 002: third groove; 100: large end;
2: metal button; 21: central hole; 22: step portion; 23: internal thread; 24: pillar portion; 25: recessed limit rib;
3: metal button cover; 31: external thread;
4: pressing upper housing; 41: limit rib; 42: engaging clip; 43: positioning post;
5: pressing lower housing; 51: limit rib; 52: engaging clip; 53: positioning post;
6: pressing spring; 7: unlocking core set;
8: latch upper housing; 81: core slot;
9: latch lower housing; 91: annular retaining portion;
10: core soft shell; 101: inner groove;
11: core conical cover; 110: inner wall; 112: angled protrusion;
12: core magnetic casting; 121: steel ball groove; 122: engagement slot;
13: steel ball; 14: core spring.

### DETAILED DESCRIPTION OF THE UTILITY MODE

The technical solutions of the embodiments of the present invention are described below in detail with reference to the accompanying drawings. It should be understood that the described embodiments represent only a portion of the embodiments of the present invention, rather than all of them. All other embodiments that may be derived by a person of ordinary skill in the art from the embodiments of the present invention without creative efforts shall fall within the protection scope of the present invention.

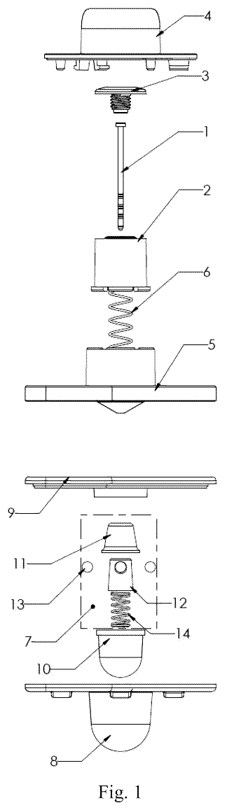

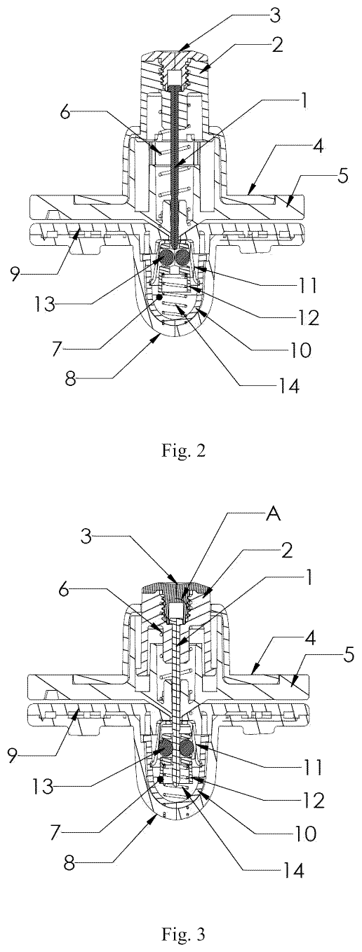

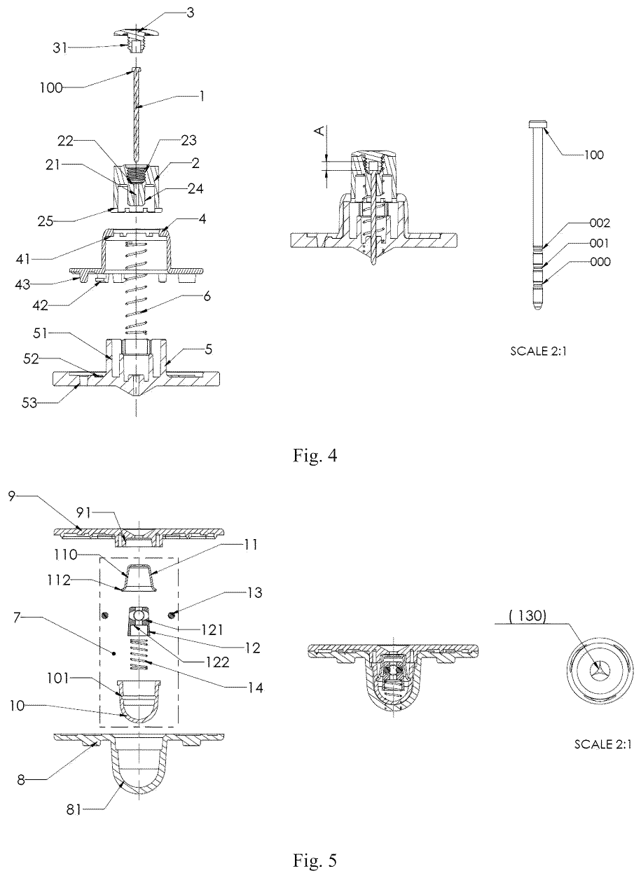

Referring to FIGS. 1-5, a security retractable latch with an anti-impact unlocking function comprises a pressing assembly and a latch assembly.

The pressing assembly comprises a steel pin 1, a metal button 2, a metal button cover 3, a pressing upper housing 4, a pressing lower housing 5, and a pressing spring 6. The steel pin 1 is passed through a central hole 21 of the metal button 2, with the large end 100 of the steel pin 1 positioned against a step portion 22 inside the central hole 21. The metal button cover 3 is screwed into an internal thread 23 of the metal button 2 via an external thread 31, allowing the steel pin 1 to slide axially between the metal button 2 and the metal button cover 3, thereby forming a free travel A. The pressing spring 6 is sleeved over a pillar portion 24 of the metal button 2. Both the pressing upper housing 4 and the pressing lower housing 5 are provided with limit ribs 41, 51 that engage with recessed limit ribs 25 of the metal button 2, and the upper and lower housings are fixedly connected via engaging clips 42, 52 and positioning posts 43, 53.

The latch assembly comprises an unlocking core set 7, a latch upper housing 8, and a latch lower housing 9. The unlocking core set 7 consists of a core soft shell 10, a core conical cover 11, a core magnetic casting 12, steel balls 13, and a core spring 14. The core magnetic casting 12 is provided with steel ball grooves 121 on its periphery and an engagement slot 122 at its bottom, with one end of the core spring 14 embedded in the engagement slot 122. The top of the core magnetic casting 12 is nested against an inner wall 110 of the core conical cover 11, while angled protrusions 112 on the outer wall of the core conical cover 11 engage with the inner grooves 101 of the core soft shell 10. The unlocking core set 7 is positioned within the core slot 81 of the latch upper housing 8, while the latch lower housing 9 is provided with an annular retaining portion 91 that restricts wobbling of the unlocking core set 7. The latch upper housing 8 and the latch lower housing 9 are fixedly connected.

The steel pin 1 body is provided with at least two sets of grooves along its axial direction. The mass of the metal button 2 is greater than the mass of the core magnetic casting 12, and the spring force of the pressing spring 6 is less than the spring force of the core spring 14.

To improve the functional performance, in this embodiment, the steel pin 1 is made of 316 stainless steel material, and the free travel A ranges from 2 mm to 6 mm.

To improve the functional performance, in this embodiment, three steel balls 13 are provided, each corresponding to and engaging with the steel ball grooves 121 on the periphery of the core magnetic casting 12.

To improve the functional performance, in this embodiment, the pressing upper housing 4 and the pressing lower housing 5 are made of plastic material, while the latch upper housing 8 and the latch lower housing 9 are fixedly joined by ultrasonic welding.

To improve the functional performance, in this embodiment, the steel pin 1 body is provided with three sets of grooves along its axial direction, namely a first groove 000, a second groove 001, and a third groove 002, wherein the spacing between adjacent sets of grooves is adapted to the free travel A.

### Working Principle and Operational Steps

Initial State: In the pressing assembly, the pressing spring 6 is in its natural extended state, pushing the metal button 2 upward. Accordingly, the steel pin 1 also moves up, with its front end retracted inside the pressing upper housing 4. In the latch assembly, the core spring 14 is in a natural extended state, pushing the core magnetic casting 12 against the top of the inner wall 110 of the core conical cover 11. The steel balls 13 are pressed by the inner wall 110 of the core conical cover 11 into the steel ball grooves 121, creating a tightened state.

Pressing to Lock: Manually press the metal button 2. The metal button 2 overcomes the spring force of the pressing spring 6 and moves downward, driving the steel pin 1 to extend towards the latch assembly. The front end of the steel pin 1 inserts into the unlocking core set 7, pushing the steel balls 13 downward, overcoming the force of the core spring 14, and moving together with the core magnetic casting 12. The spacing between the steel balls 13 gradually increases along the taper of the inner wall 110 of the core conical cover 11 until the second groove 001 or third groove 002 of the steel pin 1 aligns with the steel balls 13.

Completing Locking: When the button 2 is fully pressed, the pressing spring 6 rebounds, pushing the metal button 2 upward. The steel pin 1 is positioned and clamped between groove (001) and groove (002) (or between subsequent grooves depending on design), completing the locking. Subsequently, under the rebound force of the pressing spring 6, button 2 rises by a certain travel, allowing the steel pin to enter a free retraction state; this travel equals the aforementioned free travel A.

Applying Magnetic Force: Position a dedicated magnetic unlocker near the latch assembly. The external magnetic field exerts a downward attractive force on the core magnetic casting 12. The core magnetic casting 12 overcomes the spring force of the core spring 14 and moves downward, driving the steel balls 13 to move down synchronously.

Releasing Clamping: After the steel balls 13 move down with the core magnetic casting 12, the gap between them and the inner wall 110 of the core conical cover 11 increases, eliminating the clamping force on the steel pin 1. The rebound force of the pressing spring 6 drives the metal button 2 and the steel pin 1 to bounce upward together, retracting the pin.

### Assembly Process Steps

Pressing Assembly: \textcircled{1} Sleeve the pressing spring 6 onto the pillar portion 24 of the metal button 2. \textcircled{2} Insert the steel pin 1 from the bottom of the metal button 2 through the central hole 21, allowing the large end 100 to engage the step portion 22. \textcircled{3} Screw the metal button cover 3 into the internal thread 23 of the metal button 2, ensuring the steel pin 1 can slide freely without detachment. \textcircled{4} Place the assembled metal button sub-assembly into the pressing lower housing 5, align and snap the pressing upper housing 4 onto it, ensuring the engaging clips 42, 52 are fully engaged, completing the pressing assembly.

Latch Assembly: \textcircled{1} Insert the core spring 14 into the engagement slot 122 at the bottom of the core magnetic casting 12. \textcircled{2} Place the core magnetic casting 12 into the core soft shell 10, and place 3 steel balls 13 into the steel ball grooves 121. \textcircled{3} Cover the core conical cover 11 onto the top of the core soft shell 10, allowing the angled protrusions 112 to snap into the inner grooves 101, forming the unlocking core set 7. \textcircled{4} Place the unlocking core set 7 into the core slot 81 of the latch upper housing 8, cover with the latch lower housing 9, and fix them via ultrasonic welding (e.g., welding temperature 220° C., welding time 3s), completing the latch assembly.

Product Integration: Fix the pressing assembly, for example by sewing, to the inner side of the flap of a smartwatch storage bag, and fix the latch assembly to the corresponding position on the bag body, ensuring that the steel pin 1 can accurately insert into the unlocking core set 7 when the metal button 2 is pressed.

### Component Parameter Selection

Steel Pin 1: Made of 316 stainless steel. Fine pin version: Diameter 1.35 mm, total length 27 mm, large end 100 diameter 2.5 mm; three sets of grooves (000, 001, 002) spaced 2.5 mm apart along the axis, groove depth 0.1 mm, width 1 mm; free travel A set to 2.5 mm. Thick pin version: Diameter 2.35 mm, total length 32.5 mm, large end 100 diameter 4 mm; three sets of grooves (000, 001, 002) spaced 4.5 mm apart along the axis, groove depth 0.1 mm, width 3 mm; free travel A set to 2.5 mm.

Metal Button 2: Made of brass, mass 10 g, outer diameter 13 mm. The central hole 21 diameter (fine pin version 1.45 mm, thick pin version 2.45 mm), with a step portion 22 height of 1 mm. The internal thread 23 specification is M5×0.8. The pillar portion 24 has a diameter of 4.8 mm. The outer wall is machined with 6 uniformly distributed recessed limit ribs 25, each rib with a width of 1.4 mm and a depth of 1.2 mm.

Metal Button Cover 3: Made of aluminum alloy 6061, outer diameter 12.6 mm. The external thread 31 specification matches the metal button's internal thread 23 (M5×0.8), thickness 1.5 mm.

Pressing Spring 6 (for both fine and thick pin versions): Made of music wire, wire diameter 0.5 mm, outer diameter 6 mm, free length 26 mm, spring force 7 N.

Core Spring 14 (Fine pin version): Made of stainless steel, wire diameter 0.4 mm, outer diameter 4.7 mm, free length 8 mm, spring force 5 N.

Core Spring 14 (Thick pin version): Made of stainless steel, wire diameter 0.7 mm, outer diameter 6.1 mm, free length 10 mm, spring force 25 N.

Pressing Upper Housing 4, Pressing Lower Housing 5: Made of ABS plastic, wall thickness 1.5 mm. The inner wall of the pressing upper housing 4 is provided with 6 sets of limit ribs 41, and the inner wall of the pressing lower housing 5 is provided with 6 sets of limit ribs 51, with a rib height of 1 mm and width of 1 mm. Their edges are each provided with 3 sets of engaging clips 42, 52 and 3 positioning posts 43, 53, positioning post diameter of 2 mm, and a height of 3 mm.

Unlocking Core Set Components: Core magnetic casting 12 is made of carbon steel. Fine pin version core magnetic casting 12 mass 0.6 g, diameter 6.2 mm. Thick pin version core magnetic casting 12 mass 1.37 g, diameter 8 mm. The periphery has 3 steel ball grooves 121, each 1.5 mm deep. Steel balls 13 are made of bearing carbon steel. Fine pin version steel ball diameter 2.65 mm. Thick pin version steel ball diameter 3.15 mm. Three pieces each. Core soft shell 10 is made of TPU, with an inner diameter of 9 mm, and the inner wall is provided with 3 inner grooves 101. The core conical cover 11 is made of carbon steel, the inner wall 110 tapers 20 degrees, and the outer wall is provided with 3 sets of angled protrusions 112.

Latch Upper Housing 8, Latch Lower Housing 9: Made of ABS plastic, wall thickness 1.5 mm. The core slot 81 of the latch upper housing 8 has a diameter of 12 mm and a depth of 15 mm. The inner wall of the latch lower housing 9 is provided with an annular retaining portion 91, with a diameter of 7.5 mm and a depth of 2.3 mm.

Although embodiments of the present invention have been shown and described, it should be understood by those skilled in the art that various changes, modifications, substitutions, and alterations can be made to these embodiments without departing from the principle and spirit of the present invention. The scope of the present invention is defined by the appended claims and their equivalents.

What the claimed is

1. A security retractable latch with anti-impact unlocking function, comprising a pressing assembly and a latch assembly, characterized in that:
Said pressing assembly comprises a steel pin (1), a metal button (2), a metal button cover (3), a pressing upper housing (4), a pressing lower housing (5), and a pressing spring (6), wherein said steel pin (1) is passed through a central hole (21) of said metal button (2), with a large end (100) of said steel pin (1) positioned at a step portion (22) inside said central hole (21); said metal button cover (3) is screwed into an internal thread (23) of said metal button (2) via an external thread (31), allowing said steel pin (1) to slide axially between said metal button (2) and said metal button cover (3), thereby forming a free travel A; said pressing spring (6) is sleeved over a pillar portion (24) of said metal button (2); said pressing upper housing (4) and said pressing lower housing (5) are both provided with limit ribs (41, 51) that engage with recessed limit ribs (25) of said metal button (2), and said pressing upper housing (4) and pressing lower housing (5) are fixedly connected via engaging clips (42, 52) and positioning posts (43, 53);
said latch assembly comprises an unlocking core set (7), a latch upper housing (8), and a latch lower housing (9), said unlocking core set (7) consisting of a core soft shell (10), a core conical cover (11), a core magnetic casting (12), steel balls (13), and a core spring (14); said core magnetic casting (12) is provided with steel ball grooves (121) on its periphery and an engagement slot (122) at its bottom, with one end of said core spring (14) embedded in said engagement slot (122); a top of said core magnetic casting (12) is nested against an inner wall (110) of said core conical cover (11), with angled protrusions (112) on an outer wall of said core conical cover (11) snapping into inner grooves (101) of said core soft shell (10); said unlocking core set (7) is placed in a core slot (81) of said latch upper housing (8), said latch lower housing (9) is provided with an annular retaining portion (91) that restricts wobbling of said unlocking core set (7), and said latch upper housing (8) and said latch lower housing (9) are fixedly connected;
Wherein said steel pin (1) body is provided with at least two sets of grooves along its axial direction, a mass of said metal button (2) is greater than a mass of said core magnetic casting (12), and a spring force of said pressing spring (6) is less than a spring force of said core spring (14).

2. The security retractable latch according to claim 1, wherein said steel pin (1) is made of 316 stainless steel, and said free travel A ranges from 2 mm to 6 mm.

3. The security retractable latch according to claim 2, wherein three said steel balls (13) are provided, each correspondingly engaging with said steel ball grooves (121) on the periphery of said core magnetic casting (12).

4. The security retractable latch according to claim 3, wherein said pressing upper housing (4) and said pressing lower housing (5) are made of plastic material, and said latch upper housing (8) and said latch lower housing (9) are fixedly connected by ultrasonic welding.

5. The security retractable latch according to claim 4, wherein said steel pin (1) body is provided with three sets of grooves along its axial direction, namely a first groove (000), a second groove (001), and a third groove (002), and wherein a spacing between adjacent sets of said grooves corresponds to said free travel A.
